(19) United States
(12) Patent Application Publication
(10) Pub. No.: US 2017/0115973 A1
(43) Pub. Date: Apr. 27, 2017

(54) OPERATING METHOD OF SEMICONDUCTOR DEVICE AND SEMICONDUCTOR SYSTEM

(71) Applicant: SAMSUNG ELECTRONICS CO., LTD., SUWON-SI (KR)

(72) Inventors: JONG-WON LEE, SEONGNAM-SI (KR); JUN-MO PARK, YONGIN-SI (KR)

(21) Appl. No.: 15/292,608

(22) Filed: Oct. 13, 2016

(30) Foreign Application Priority Data
Oct. 26, 2015 (KR) 10-2015-0148715

(51) Int. Cl. G06F 9/45

(52) U.S. Cl. CPC G06F 8/4441; G06F 8/48

(57) ABSTRACT

An operating method of a semiconductor device includes searching for a loop code from an original Intermediate Representation (IR) generated by a compiler; determining whether the loop code satisfies a predefined condition; calculating the loop code using an interpreter separate from the compiler when the loop code is determined to satisfy the predefined condition, wherein the interpreter includes an interpreter frame; storing a result of the calculating the loop code in the interpreter frame; and substituting the loop code in the original IR with an access code for accessing the result to generate an updated IR.

This application claims priority to Korean Patent Application No. 10-2015-0148715 filed on Oct. 26, 2015 in the Korean Intellectual Property Office, the disclosure of which is incorporated by reference in its entirety herein.

### BACKGROUND

1. Technical Field

The inventive concept relates to an operating method of a semiconductor device and a semiconductor system.

2. Discussion of Related Art

In computer programming, source code is a text file version of a computer program or software including instructions written in a programming language (the source language). A compiler is a computer program that transforms the source code into target code of another computer language (the target language). For example, the target code typically has a binary form known as object code. In compiler theory, loop optimization is the process of increasing execution speed by reducing the overheads associated with loops. Therefore, any loops or iterations need to be optimized to reduce the execution time of the target code generated by compiling the source. For example, a loop simplification technique based on chains of recurrences (CR) may be applied to simplify loops within the target code and may thus reduce the execution time of the target code. However, it may not be possible to apply this technique under certain circumstances. Thus, a technique is needed to optimize loops that is not based on CR.

### SUMMARY

Exemplary embodiments of the inventive concept provide an operating method of a semiconductor device, a computer-readable recording medium, and semiconductor system, which are capable of optimizing loops even when the number of iterations of a loop is affected by variables other than an induction variable in the loop.

According to an exemplary embodiment of the present inventive concept, there is provided an operating method of a semiconductor device including searching for a loop code from an original Intermediate Representation (IR) generated by a compiler; determining whether the loop code satisfies a predefined condition; calculating the loop code using an interpreter separate from the compiler when the loop code is determined to satisfy the predefined condition; storing a result of the calculating the loop code in an interpreter frame of the interpreter; and substituting the loop code in the original IR with an access code for accessing the result to generate an updated IR.

According to an exemplary embodiment of the present inventive concept, there is provided an operating method of a semiconductor device including a compiler compiling source code to generate an Intermediate Representation (IR); searching the original IR for a loop code; generating an Extended IR (EIR) code that corresponds to an IR code included in the loop code and includes an extended operator corresponding to an operator of the IR code, an interpreter separate from the compiler calculating the EIR code by executing the extended operator, substituting the loop code in the original IR with an access code for accessing a result of the calculating the EIR code to generate an updated IR; and the compiler compiling the updated IR.

According to an exemplary embodiment of the present inventive concept, there is provided an operating method of a semiconductor device including generating an original Intermediate Representation (IR), which includes virtual register information regarding a virtual register, by performing a first compilation using a compiler, searching the original IR for a loop code, generating an Extended IR (EIR) code, which corresponds to an IR code included in the loop code and includes interpreter frame information regarding an interpreter frame allocated to a memory separately from the virtual register calculating the EIR code using an interpreter, which accesses the interpreter frame and is executed separately from the compiler; storing a result value, which is a result of the calculating the EIR code, in the interpreter frame; substituting the loop code in the original IR with an access code for accessing the result value to generate an updated IR; and performing a second compilation on the updated IR using the compiler.

According to an exemplary embodiment of the present inventive concept, there is provided a computer-readable recording medium including instructions causing a processor to, search for a loop code from an Intermediate Representation (IR) generated by a compiler; determine whether the loop code satisfies a predefined set of conditions, generate an interpreter framework to calculate the loop code separately from the compiler, the interpreter framework including an interpreter which calculates the loop code, and an interpreter frame which is for storing an intermediate value obtained from the calculation of the loop code; calculate the loop code using the interpreter, store a result value, which is a result of the calculation of the loop code, in the interpreter frame, and substitute the loop code in the IR with an access code for accessing the result value.

According to an exemplary embodiment of the present inventive concept, there is provided a semiconductor system, including a compiler for generating an original Intermediate Representation (IR) from a source code, and an interpreter for receiving an Extended IR (EIR) code, which corresponds to an IR code included in a loop code of the original IR and uses an extended operator corresponding to an operator of the IR code, wherein the interpreter calculates the loop code by executing the EIR code and substitutes the loop code in the IR with an access code for accessing a result of the calculation of the loop code.

According to an exemplary embodiment of the present inventive concept, there is provided a method of optimizing a computer program including: compiling source code into an original Intermediate Representation (IR); determining whether loop code in the original IR satisfies a condition; executing the loop code to generate a result value, substituting the loop code in the original IR with an access code for accessing the result value to generate an updated IR and compiling the updated IR into target code, when the determining determines the loop code satisfies the condition; and compiling the original IR into the target code, when the loop code does not satisfy the condition.

### BRIEF DESCRIPTION OF THE DRAWINGS

Exemplary embodiments of the inventive concept will be more clearly understood from the following detailed description taken in conjunction with the accompanying drawings.

FIG. 1 is a schematic view illustrating an operating method of a semiconductor device, according to an exemplary embodiment of the inventive concept.

FIG. 2 is a schematic view illustrating an interpreter framework according to an exemplary embodiment of the inventive concept.

FIG. 3 is a schematic view illustrating Extended Intermediate Representation (EIR) code according to an exemplary embodiment of the inventive concept.

FIGS. 4 through 11 are schematic views illustrating the operating method according to an exemplary embodiment of the inventive concept.

FIG. 12 is a flowchart illustrating the operating method according to an exemplary embodiment of the inventive concept.

FIG. 13 is a flowchart illustrating an operating method of a semiconductor device, according to an exemplary embodiment of the inventive concept.

FIG. 14 is a block diagram of an exemplary electronic system to which an operating method of a semiconductor device and a semiconductor system according to exemplary embodiments of the inventive concept are applicable.

FIGS. 15 through 17 are schematic views illustrating exemplary semiconductor systems to which operating methods of semiconductor devices according to exemplary embodiments of the inventive concept are applicable.

### DETAILED DESCRIPTION OF THE EXEMPLARY EMBODIMENTS

FIG. 1 is a schematic view illustrating an operating method of a semiconductor device, according to an exemplary embodiment of the inventive concept.

Referring to FIG. 1, a semiconductor system 1 receives source code and outputs target code, and includes a front end 50, an interpreter framework 100, and a back end 150. In an embodiment, the semiconductor system 1 includes one or more processors and semiconductor memory. In an embodiment, the front end 50, the interpreter framework 100, and the back end 150 are computer programs stored within the memory that are executable by the one or more processors. In another embodiment, each of the front end 50, the interpreted framework 100, and the back end 150 are implemented by a different one of the processors, respectively, or by a same single processor.

The source code is a code written in a programming language. For example, the source code may be written in a language such as the C language, which can be compiled. However, the inventive concept is not limited source code of any particular programming language.

The target code is code having a form that can be executed by a computing system, for example, a binary form. For example, the target code may be an object code or a machine code. The target code may be represented in various manners depending on the type of target platform (e.g., a platform in which the target code is to be executed).

The front end 50 generates an original Intermediate Representation (IR) 20 by analyzing the source code. The original IR 20 may be an internal or intermediate representation of a program. The original IR 20 is different from the source code and is derivable from the source code. In an embodiment, the front end 50 manages a symbol table and a data structure that maps various symbols of the symbol table in the source code to information such as location, type, and scope. In an embodiment, the front end 50 manages a data structure that includes an entry for each identifier in the source code that is associated with information related to the identifier's declaration or appearance in the source code, and the data structure is used by a compiler to compile the source code.

The interpreter framework 100 receives the original IR 20, which is generated by the front end 50. The interpreter framework 100 searches for a loop code from the original IR 20, calculates a result value of the loop code, and outputs an updated IR 22, which is obtained by substituting the loop code with an access code that accesses the result value. For example, if the loop code is repeatedly executing a function to return a value and adding the value to a variable, the result value of the loop code could be the final value of the variable.

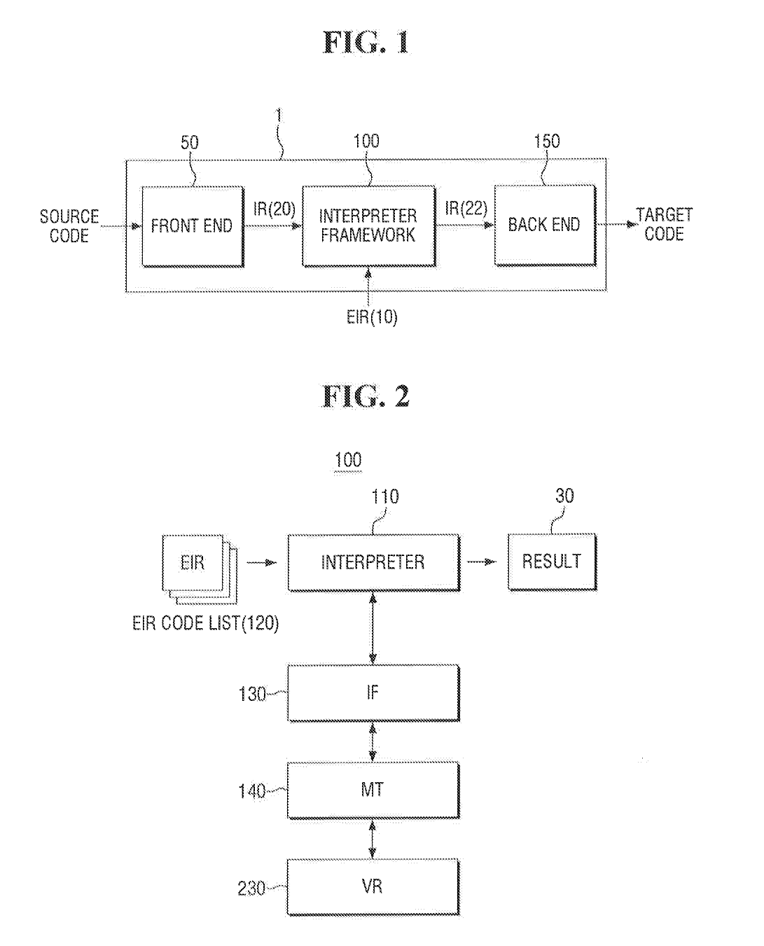

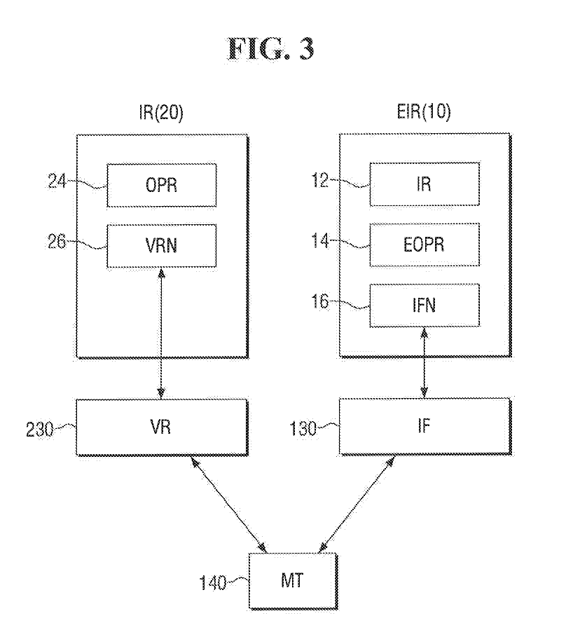

The interpreter framework 100 uses an interpreter 110 to calculate or execute the loop code. The interpreter 110 calculates the loop code by executing an Extended IR (EIR) 10 corresponding to the original IR 20, and the EIR 10 may be a representation for processing in an interpreter zone, which is distinguished from a compiler zone such as the front end 50 and the back end 150. The EIR 10 will be described later in detail with reference to FIGS. 2 and 3.

The back end 150 collects program information from the original IR 20, which is generated by the front end 50, or from the updated IR 22, which is generated by the interpreter framework 100, and optimizes the original IR 20 or the updated IR 22. For example, the optimization of the original IR 20 or the updated IR 22 may include processes such as inline expansion, dead code elimination, loop transformation, and register allocation. In an embodiment, the inline expansion replaces a function name with the body of the called function. In an embodiment, dead code elimination removes code that is determined not to affect the program results. Examples of the loop transformation include breaking up loop code into multiple smaller loops, combining smaller loops into a single larger loop, exchanging inner loops with outer loops, restructuring loop code to run efficiently on multiprocessor systems, etc. The back end 150 generates a target code (e.g., a machine code) from the optimized IR 20 or 22, and outputs the target code. For example, the target code can be generated from the updated IR code 22 or from the original IR code 20.

FIG. 2 is a schematic view illustrating an interpreter framework according to an exemplary embodiment of the inventive concept.

Referring to FIG. 2, the interpreter framework 100 includes the interpreter 110, an EIR code list 120, an interpreter frame 130, and a mapping table 140.

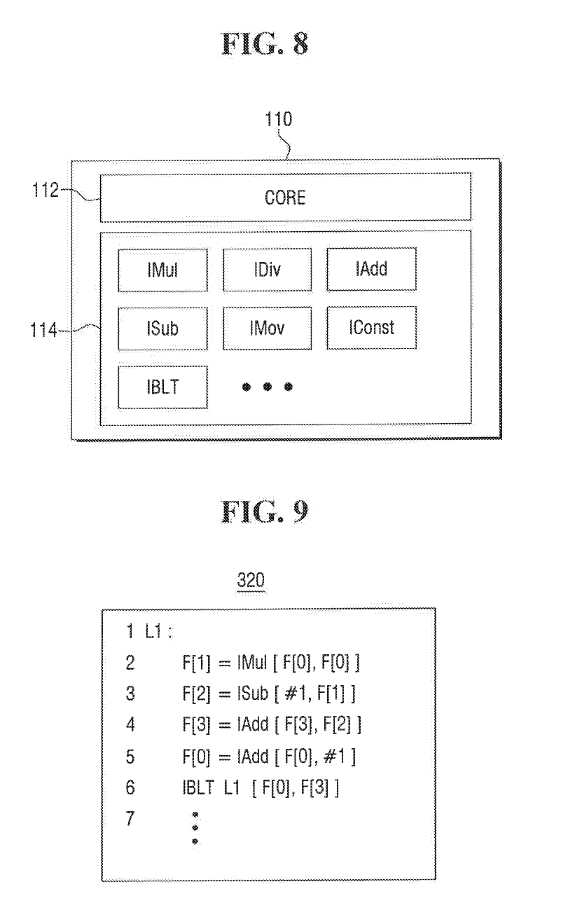

The interpreter 110 calculates a loop code. The loop code is included in the original IR 20 generated by the front end 50. In an exemplary embodiment, the interpreter 110 interprets the EIR 10 corresponding to the original IR 20, instead of directly interpreting the original IR 20. For this, the interpreter 110 may include an extended operator set 114 including extended operators. The extended operators are codes included in the original IR 20 (e.g., codes or operators of the EIR 10). The extended operator set 114 will be described later in detail with reference to FIG. 8.

The interpreter 110 may receive the EIR 10, and particularly, the EIR code list 120 including EIR codes. That is, the interpreter 110 may receive a plurality of EIR codes and may finally calculate the loop code by sequentially executing the plurality of EIR codes. The structure of the EIR 10 will be described later in detail with reference to FIG. 3.

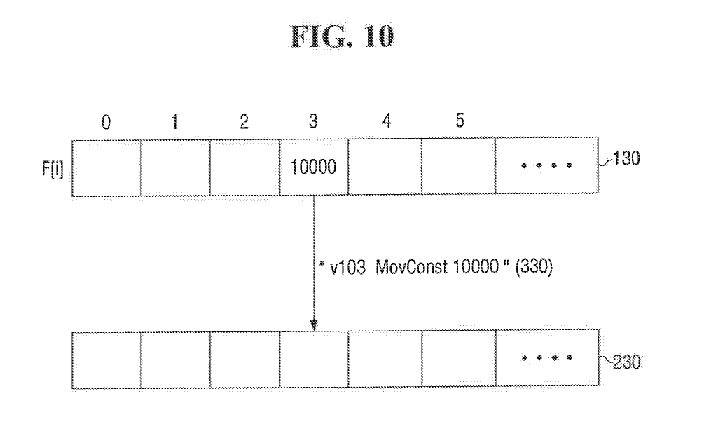

The interpreter 110 generates a result value 30, which is the result of calculating or executing the loop code. The result value 30 may be stored in the interpreter frame 130 and may be used to generate an access code to replace the loop code of the original IR 20. For example, the access code may be generated in a virtual register 230 corresponding to the interpreter frame 130 as a code storing the result value 30. In an exemplary embodiment, the virtual register 230 represents one or more fields logically implemented in consecutive memory locations. The access code will be described later in detail with reference to FIG. 10.

In an exemplary embodiment, the interpreter 110 is executed separately from a compiler. More specifically, the interpreter framework 110 including the interpreter 110 may be executed in response to a calculable loop code, which is a loop code that can be substituted with a result value, being discovered from the original IR 20. In other words, the interpreter framework 100 including the interpreter 110 is not executed during a compilation time if no calculable loop code is discovered from the original IR 20. In an embodiment when the interpreter 110 is not executed, the original IR 20 passes directly to the back end 150.

A calculable loop code may be a loop code satisfying a predefined set of conditions. In an exemplary embodiment, a determination is made as to whether the loop code discovered from the original IR 20 satisfies the predefined set of conditions by determining at least one of whether the loop code discovered from the IR 20 is an innermost loop, whether the loop code is provided as a single basic block without having any branch code, and whether the loop code includes a single preheader block and a single exit block. In an exemplary embodiment, a determination is made as to whether the loop code discovered from the original IR 20 satisfies the predefined set of conditions by determining whether the loop code does not include any memory access code (e.g., an instruction that accesses memory) or a function call code (e.g., a instruction that invokes a function). In an exemplary embodiment, the conditions are not satisfied if the loop code includes a memory access code or a function call code.

In an exemplary embodiment, the interpreter 110 calculates the loop code during a compilation time. That is, the interpreter 110 may be interposed between the front end 50 and the back end 150 of the compiler. More specifically, the interpreter 110 may receive the original IR 20 generated by the front end 50, substitute an IR code within the original IR 20 corresponding to the loop code with an access code to generate the updated IR 22 (substituted IR), and may thus output the substituted IR 22. The substituted IR 22 may be processed by a compiler at the back end 150. As a result, the target code may be generated. The target code may be generated by the compiler at the back end 150 by compiling the original IR 20 when the above-described optimization cannot be performed.

The interpreter frame 130 and the mapping table 140 will hereinafter be described with reference to FIG. 2.

The interpreter frame 130 is a storage space that the interpreter 110 uses to calculate a loop code. That is, the interpreter 110 write values to, or read values from, the interpreter frame 130, and the values may be initial values, intermediate values (for use during computation), and final values (obtained by computation) of variables for computing an EIR code.

The interpreter frame 130 is distinguished from the virtual register 230, which is used by the compiler. In an exemplary embodiment, the interpreter frame 130 is allocated to a memory, separately from the virtual register 230. For example, the memory may include a first section representing the virtual register 230 and a second section distinct from the first section representing the interpreter frame 130. If an IR code includes virtual register information, an EIR code corresponding to the IR code may include interpreter frame information regarding an interpreter frame allocated to correspond to the virtual register used in the IR code.

The interpreter frame 130 may include a plurality of unit frames, and the unit frames may have a predetermined size. In an exemplary embodiment, the unit frames have a 4-byte size, but the inventive concept is not limited thereto.

If the size of the unit frame is 4 bytes and the size of the operand to be processed by the interpreter 110 is 8 or 16 bytes, the plurality of consecutive unit frames may be matched to a single value or a single virtual register. For example, if the interpreter frame 110 includes a first unit frame and a second unit frame, which are consecutive to each other, the first unit frame and the second unit frame may be matched to a single value or a single virtual register.

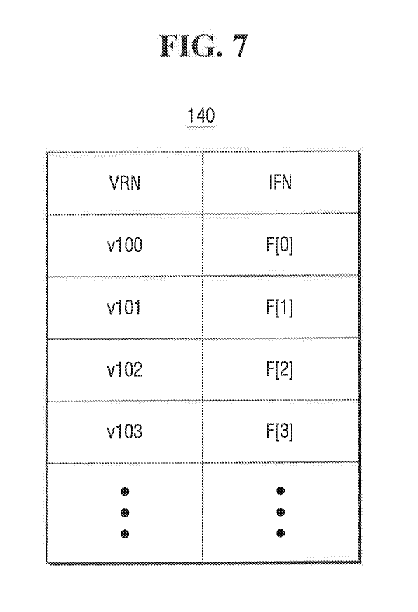

The mapping table 140 stores a mapping relationship between the interpreter frame 130 and the virtual register 230. The structure of the mapping table 140 will be described later in detail with reference to FIG. 7. In an exemplary embodiment, the mapping table 140 is stored in a memory space or storage space that is accessible by the interpreter 110.

FIG. 3 is a schematic view illustrating an EIR code according to an exemplary embodiment of the inventive concept.

FIG. 3 illustrates an embodiment of both the original IR 20 and the EIR 10.

The original IR 20 is generated by a compiler at the front end 50 and includes an IR code having an operator 24 and virtual register information (or a virtual register number (VRN)) 26. The compiler uses the virtual register 230 to process the initial values, intermediate values (for use during computation), and final values (obtained by computation) of variables for computing the original IR 20.

The EIR 10 is generated to correspond to the original IR 20 and includes an EIR code having an extended operator 14 and interpreter frame information (or an interpreter frame number (IFN)) 16. The interpreter 110 uses the interpreter frame 130 to process the initial values, intermediate values (for use during computation), and final values (obtained by computation) of variables for computing the EIR 10.

In an exemplary embodiment, the EIR 10 includes an original version of the original IR 20. That is, the EIR 10 may include an IR 12.

As described above with reference to FIG. 2, the mapping relationship between the virtual register 230 and the interpreter frame 130 may be managed by the mapping table 140.

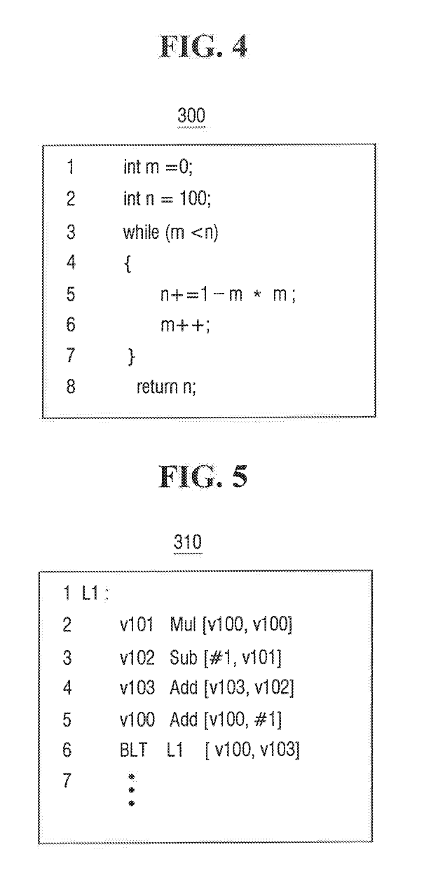

FIGS. 4 through 11 are schematic views illustrating the operating method according to the exemplary embodiment of the inventive concept.

FIG. 4 illustrates a source code 300 in the C language, which is to be processed by the operating method according to the exemplary embodiment of FIG. 1.

Referring to FIG. 4, the source code initializes integer-type variables m and n, includes a “while” statement as a loop code, and includes a code that returns the value of the variable n. The variable m may be an induction variable, and the variable n may be a local variable. An induction variable may a variable that is increased or decreased by a fixed amount every iteration of a loop.

It is noteworthy that the “while” statement includes a loop condition “m<n”, and that the variable m is an induction variable whose value increases in the “while” loop and the value of the variable n varies under the influence of the variable m in the “while” loop. That is, the source code of FIG. 4 includes the induction variable m and the non-induction variable n, and the number of iterations of the “while” loop is affected not only by the induction variable m, but also by the non-induction variable n. In other words, the number of iterations of the “while” loop is determined by both the induction variable m and the non-induction variable n.

A loop simplification method based on chains of recurrences (CR) cannot be applied to a situation where the number of iterations of a loop code is affected by variables other than an induction variable. For example, a loop simplification method based on CR cannot be applied to the loop code depicted in FIG. 4. However, according to an embodiment of the inventive concept, even when the number of iterations of a loop code is affected by variables, other than an induction variable, in the loop code, the execution time of a target code corresponding to a loop can be effectively reduced by substituting the loop code with a result value.

FIG. 5 illustrates an IR 310 that may comprise an original IR 20 or IR codes obtained by compiling the source code of FIG. 4.

Referring to FIG. 5, “v100”, “v101”, “V102”, and “v103” denote VRNs representing virtual registers 230 yet to be allocated to a memory, and “Mul” (e.g., a multiplication operator), “Sub” (e.g., a subtraction operator), “Add” (e.g., an addition operator), and “BLT” (e.g., branch on less than operator) denote operators used in the original IR 20.

Typically, once codes of the original IR 20 are generated by the front end 50, the back end 150 maps virtual registers 230 to an actual memory space, and generates a final target code. However, in an exemplary embodiment of the inventive concept, a calculable loop code is searched for first from among the codes of the original IR 20 of FIG. 5. Then, if there is a calculable loop code among the codes of the original IR 20 of FIG. 5, an updated IR 22 is obtained by eliminating the calculable loop code and inserting an access code that accesses a result value of the calculable loop code, and the updated IR 22 is transmitted to the back end 150. For example, the loop code is removed from the original IR 20 and replaced with the access code to generate the updated IR 22.

Referring to FIG. 5, a loop beginning with the label “L1:” is an innermost loop, is provided as a single basic block, and includes a single preheader block and a single exit block. Since the loop beginning with the label “L1:” does not include a memory access code or a function call code, the loop beginning with the label “L1:” corresponds to a calculable loop code that is calculable by the interpreter framework 100. In an embodiment, a loop code is the innermost loop when the loop code is the inner most loop within one or more outer loop codes or when the loop code is not located within another loop code. In an embodiment, loop code has a single exit block when it does not include multiple branches. In an embodiment, loop code has a single preheader block when it branches to no more than one label.

Thus, the original IR 20 is converted into an EIR 10 that can be processed by the interpreter 110. The conversion of the original IR 20 includes allocating interpreter frames 130 corresponding to the virtual registers v100, v101, v102, or v103 and selecting extended operators for the operators Mul, Sub, Add, or BLT.

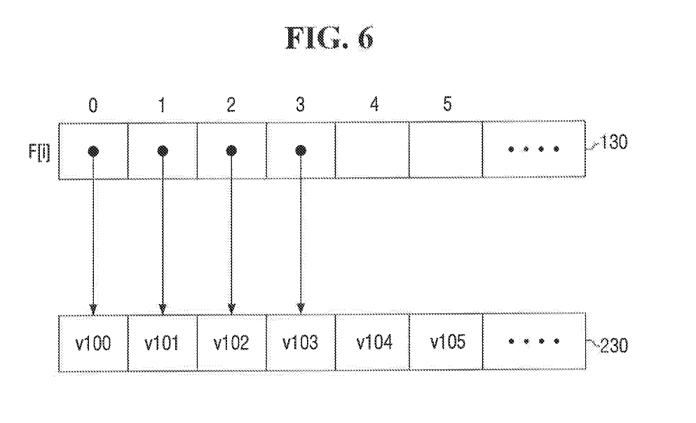

Referring to FIG. 6, “F[i]” denotes the interpreter frames 130. For convenience, the interpreter frames 130 are illustrated in FIG. 6 as being represented by an index i that gradually increases from 0, but the structure of the interpreter frames 130 is not limited to that illustrated in FIG. 6, but may vary depending on the intended use of the interpreter frames 130.

To convert the VRNs of the original IR 20 of FIG. 5 into IFNs, the interpreter frames F[0], F[1], F[2], and F[3] may be allocated to correspond to the virtual registers v100, v101, v102, and v103, respectively. Since virtual registers v104 and v105 are not used in the original IR 20 of FIG. 5, no interpreter frames are allocated for the virtual registers v104 and v105.

Referring to FIG. 7, a mapping table 140 includes a VRN column and an IFN column, and stores the mapping relationships between the virtual registers 230 and the interpreter frames 130, i.e., the mapping relationships between the virtual registers v100, v101, v102, and v103 and the interpreter frames F[0], F[1], F[2], and F[3]. The mapping table 140 showing the mapping relationships between the virtual registers 230 and the interpreter frames 130 is illustrated in FIG. 7, but the form of data showing the mapping relationships between the virtual registers 230 and the interpreter frames 130 is not limited to that illustrated in FIG. 7, but may vary.

Referring to FIG. 8, the interpreter 110 includes a core 112 and an extended operator set 114. In an embodiment, the core 112 is a processing core of a multi-core processor.

The core 112 interprets the EIR 10 and calculates the loop code using operators and operands included in the codes of the EIR 10.

The extended operator set 114 corresponds to the operators included in the original IR 20 and includes extended operators that can be calculated by the interpreter 110. For example, operators “Mul”, “Div” (e.g., a division operator), “Add”, “Sub”, “Mov” (e.g., a move operator), “Const”, and “BLT” of the original IR 20 may correspond to extended operators “IMul”, “IDiv”, “IAdd”, “ISub”, “IMov”, “IConst”, and “IBLT”, respectively, of the EIR 10.

In the present exemplary embodiment, the operators of the EIR 10 are named by adding the character “T” at the end of the names of their respective counterparts of the IR 10, but the inventive concept is not limited thereto. That is, the operators of the EIR 10 may be named in various manners, other than that set forth herein. For example, the operators of the EIR 10 may have the same names as their respective counterparts of the IR 20.

FIG. 9 illustrates an EIR 320 that may correspond to an EIR 10, which in turn corresponds to the original IR 20 of FIG. 5.

Referring to FIGS. 5 and 9, the VRNs “v100”, “v101”, “v102”, and “v103” of the original IR 20 are converted into the IFRs “F[0]”, “F[1]”, “F[2]”, and “F[3]”, respectively, of the EIR 10, and the operators “Mul”, “Sub”, “Add”, and “BLT” of the original IR 20 are converted into the extended operators “IMul”, “ISub”, “IAdd”, and “IBLT”, respectively, of the EIR 10.

The interpreter 110 calculates the EIR 10, thereby generating a final result value 30 of the loop code of the original IR 20.

FIG. 10 illustrates an access code according to an exemplary embodiment of the inventive concept.

The access code, which is a code to substitute the loop code of the original IR 20, includes a code for accessing the result value 30 obtained by the interpreter 110. More specifically, if the result value 30, which is obtained by computing the loop code of the original IR 20 using the EIR 10 of FIG. 9, is “10000”, the interpreter 110 stores the result value of “10000” in the interpreter frame F[3] corresponding to the virtual register v103.

Thereafter, the loop code is eliminated from the original IR 20, and an access code 330 is inserted into the original IR 20. In the present exemplary embodiment, the access code 330 is “v103 MovConst 10000”, which is a code for storing a constant value of “10000” in the virtual register v103, but the inventive concept is not limited thereto. The form of the access code 330 is not limited to that illustrated in FIG. 10, but may vary.

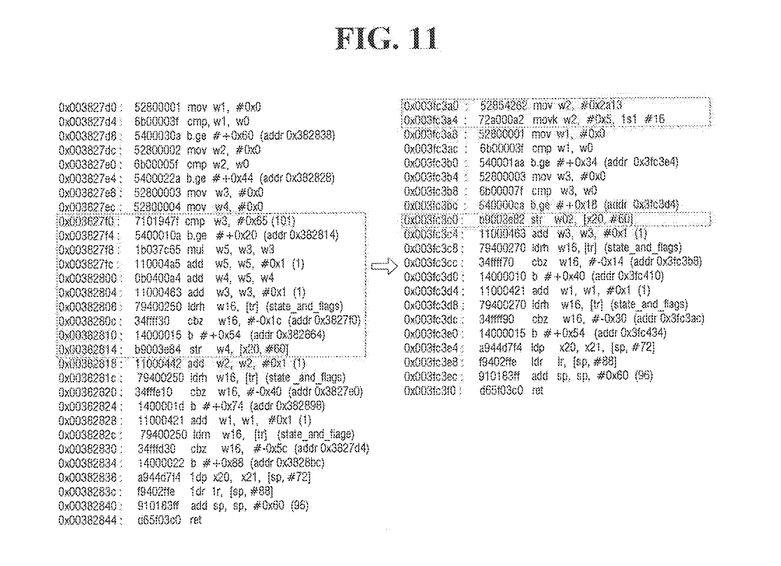

More specifically, as shown in the left part of FIG. 11, the loop code is eliminated from the original IR 20, and as shown in the right part of FIG. 11, a code “str w2, [x20, #60]” for storing a result value w2 in a memory is inserted instead.

According to an embodiment of the inventive concept, the execution time of a target code corresponding to a loop can be effectively reduced by substituting a loop code with a result value. Also, as already mentioned above, the substitution of the loop code with the result value may be possible even when the number of iterations of the loop code is affected by variables other than an induction variable.

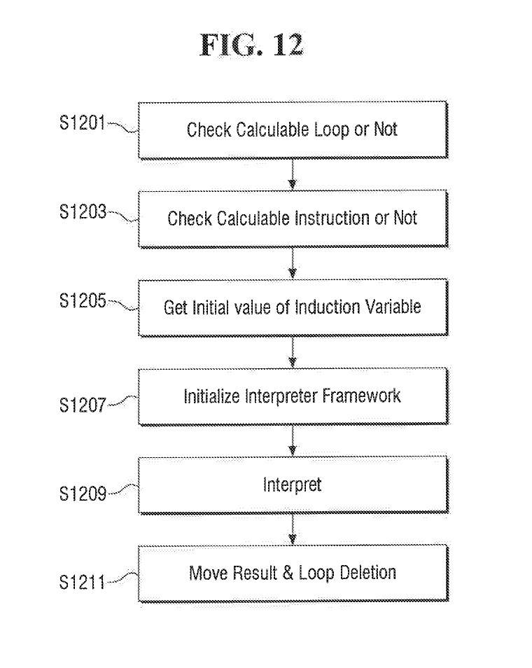

FIG. 12 is a flowchart illustrating the operating method according to an exemplary embodiment of the inventive concept.

Referring to FIG. 12, a determination is made as to whether a loop code is calculable (S1201). More specifically, a determination may be made as to whether the loop code is calculable by determining at least one of whether the loop code is an innermost loop, whether the loop code is provided as a single basic block without having any branch code, and whether the loop code includes a single preheader block and a single exit block.

Thereafter, a determination is made as to whether the loop code includes a calculable instruction (S1203). For example, this determination may be performed by checking whether the loop code includes any memory access code or function call code.

Thereafter, the initial value of an induction variable included in the loop code is determined (S1205). In an exemplary embodiment, the determination of the initial value of the induction value includes storing the initial value of the induction variable in an interpreter frame 130.

Thereafter, the interpreter framework 100 is initialized (S1207). In an exemplary embodiment, the initialization of the interpreter framework 100 includes mapping a virtual register 230 and an interpreter frame 130 and initializing the interpreter frame 130 to an arbitrary constant value.

Thereafter, the loop code is calculated (e.g., interpreted) using the interpreter 110 of the interpreter framework 100 (S1209), and a result value 30 obtained by the calculation is stored in the interpreter frame 130, and the loop code is eliminated from an IR 20 (S1211). The elimination of the loop code may include substituting the loop code in the original IR 20 with an access code for accessing the result value 30.

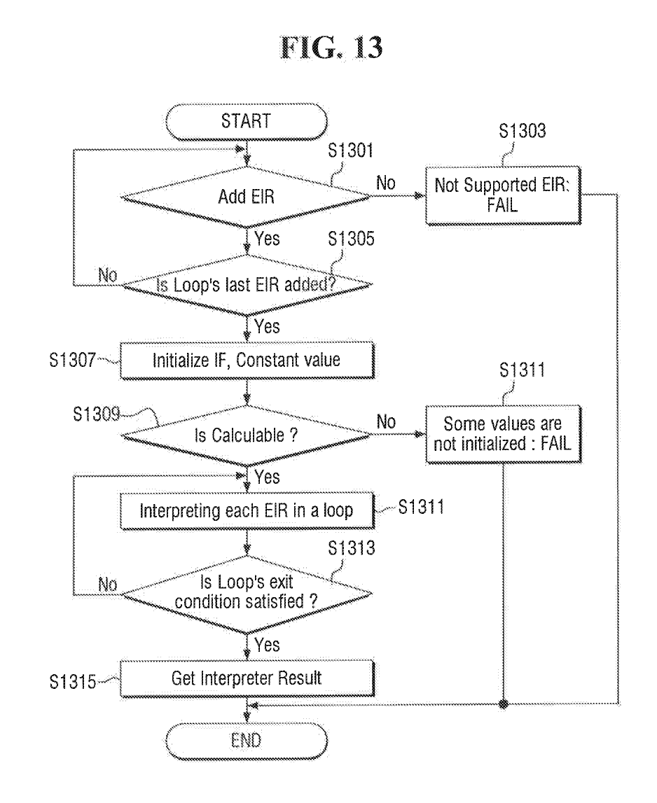

FIG. 13 is a flowchart illustrating a method of operating a semiconductor device, according to an exemplary embodiment of the inventive concept.

Referring to FIG. 13, EIR codes of an EIR 10 are added to the interpreter framework 100 (S1301), and a determination is made as to whether the EIR codes are supported by the interpreter framework 100. If the EIR codes are not supported by the interpreter framework 100, an error message is output, and the operation of the interpreter framework 100 is terminated (S1303).

While inspecting the EIR codes to determine whether they are supported by the interpreter framework 100, all IR codes of a loop code are added to the interpreter framework 100 (S1305). For example, the method may attempt to add multiple EIR codes to the interpreter frame work 100, and assuming they are all supported, the method would then proceed to step S1307.

Thereafter, an interpreter frame 130 is initialized (S1307), and a determination is made as to whether the EIR codes are calculable (S1309). If the EIR codes are incalculable due to, for example, an initialization failure, an error message is output, and the operation of the interpreter framework 100 is terminated (S1311).

Thereafter, each of the EIR codes in a loop code is processed using the interpreter 110 (S1311) while determining whether an exit condition of the loop code is satisfied (S1313).

In response to a determination being made that the exit condition of the loop code is satisfied, i.e., the iteration of a loop has completed, a result value 30, which is the result of calculating the loop code, is obtained (S1315).

According to an embodiment of the inventive concept, the execution time of a target code corresponding to a loop can be effectively reduced by substituting a loop code with a result value. Also, as already mentioned above, the substitution of the loop code with the result value may be possible even when the number of iterations of the loop code is affected by variables other than an induction variable.

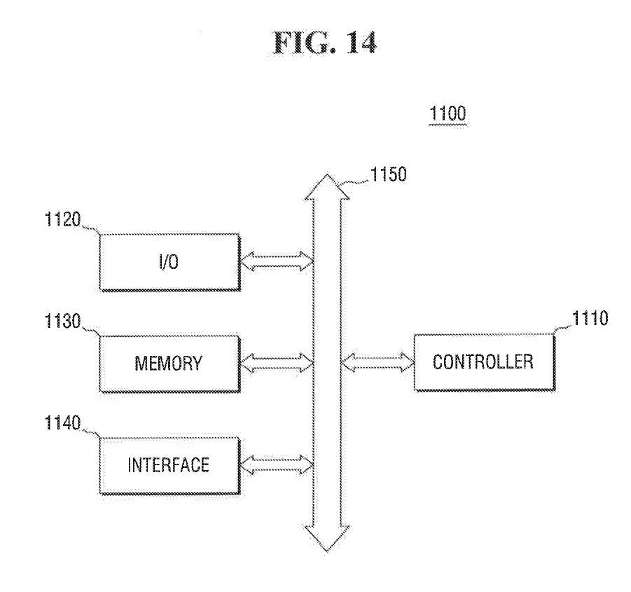

FIG. 14 is a block diagram of an exemplary electronic system to which an operating method of a semiconductor device and a semiconductor system according to exemplary embodiments of the inventive concept are applicable.

Referring to FIG. 14, an electronic system 1100 includes a controller 1110, an input/output (I/O) device 1120, a memory device 1130, an interface 1140, and a bus 1150. The controller 1110, the I/O device 1120, the memory device 1130, and/or the interface 1140 may be connected to one another via the bus 1150. The bus 1150 may be a path via which data is transmitted. For example, the functions of the front end 50, the interpreter framework 100, and the back end 150 may be performed by the controller 1110. For example, the controller 1110 may execute one or more steps of FIG. 12 or FIG. 13. For example, the controller 1110 may be used to implement all or a part of the semiconductor device system 1.

The controller 1110 may include at least one of a microprocessor, a digital signal processor, a microcontroller, and a logic element performing similar functions to a microprocessor, a digital signal processor, or a microcontroller. Examples of the I/O device 1120 include a keypad, a keyboard, a display device, and the like. The memory device 1130 may store data and/or commands. The interface 1140 transmits data to or receives data from a communication network. The interface 1140 may be a wired or wireless interface. Examples of the interface 1140 include an antenna, a wired or wireless transceiver, and the like.

Although not specifically illustrated, the semiconductor system 1100 may also include an operating memory for improving the operation of the controller 1110, such as a high-speed dynamic random access memory (DRAM) and/or static random access memory (SRAM).

The semiconductor system 1110 may be applicable to a Personal Digital Assistant (PDA), a portable computer, a web tablet, a wireless phone, a mobile phone, a digital music player, a memory card, or any type of electronic product capable of transmitting and/or receiving information in a wireless environment.

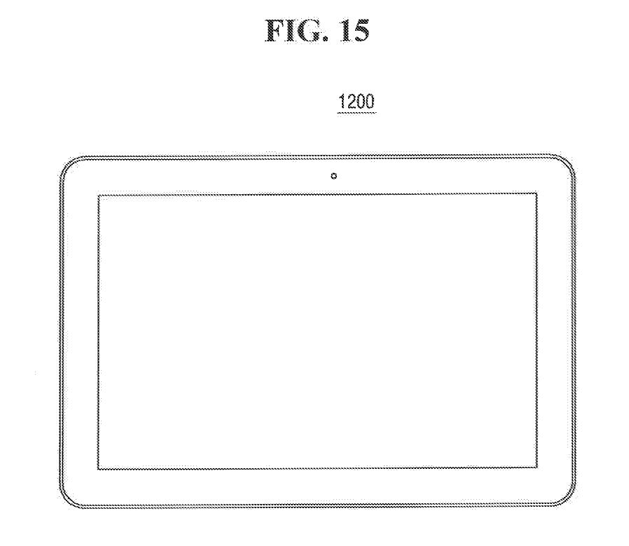

FIGS. 15 through 17 are schematic views illustrating exemplary semiconductor systems to which operating methods of semiconductor devices according to exemplary embodiments of the inventive concept are applicable.

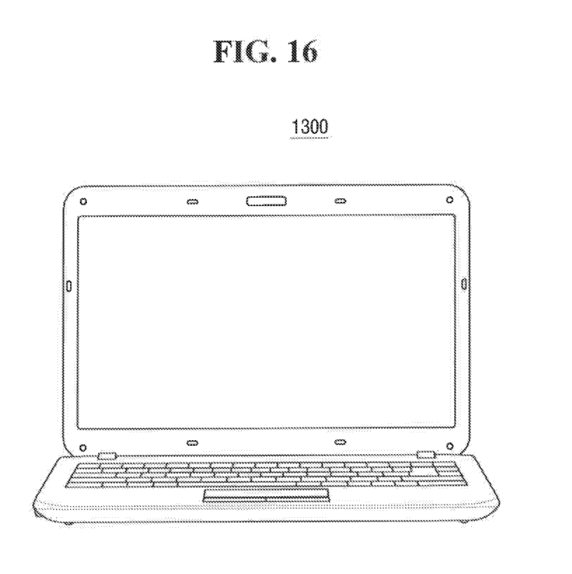

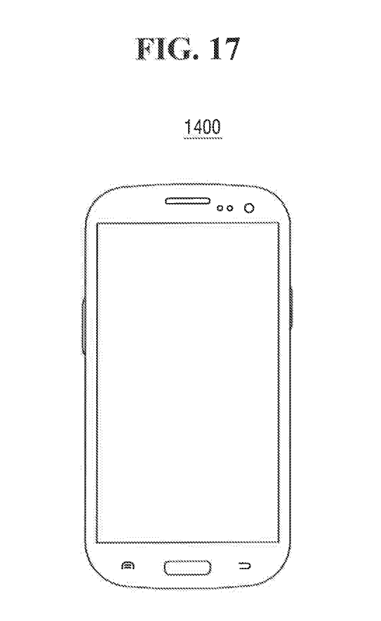

More specifically, FIG. 15 illustrates a tablet PC 1200, FIG. 16 illustrates a notebook computer 1300, and FIG. 17 illustrates a smartphone 1400. At least one of the semiconductor devices according to exemplary embodiments of the inventive concept may be used in the tablet PC 1200, the notebook computer 1300, and the smartphone 1400.

The semiconductor devices according to exemplary embodiments of the inventive concept may also be used in various integrated circuit (IC) devices other than those set forth herein.

That is, examples of a semiconductor system (e.g., 1) according to an exemplary embodiment of the inventive concept include the tablet PC 1200, the notebook computer 1300, but the inventive concept is not limited thereto.

The semiconductor system according to an exemplary embodiment of the inventive concept may be provided as a computer, an Ultra Mobile PC (UMPC), a work station, a net-book computer, a PDA, a portable computer, a wireless phone, a mobile phone, an e-book, a portable multimedia player (PMP), a portable game console, a navigation device, a black box, a digital camera, a 3-dimensional television set, a digital audio recorder, a digital audio player, a digital picture recorder, a digital picture player, a digital video recorder, or a digital video player.

The above-described methods may be stored on a computer readably storage medium, which is a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

The foregoing is illustrative of exemplary embodiments of the inventive concept and is not to be construed as limiting thereof. Although a few exemplary embodiments have been described, those skilled in the art will readily appreciate that many modifications are possible in the exemplary embodiments without materially departing from the present inventive concept. Accordingly, all such modifications are intended to be included within the scope of the present inventive concept.

1. An operating method of a semiconductor device, comprising:
searching for a loop code from an original Intermediate Representation (IR) generated by a compiler;
determining whether the loop code satisfies a predefined condition;
calculating the loop code using an interpreter separate from the compiler when the loop code is determined to satisfy the predefined condition, wherein the interpreter includes an interpreter frame;
storing a result of the calculating the loop code in the interpreter frame; and
substituting the loop code in the original IR with an access code for accessing the result to generate an updated IR.

2. The operating method of claim 1, wherein the determining whether the loop code satisfies the predefined condition, comprises determining at least one of whether the loop code is an innermost loop, whether the loop code is provided as a single basic block, and whether the loop code includes a single preheader block and a single exit block.

3. The operating method of claim 1, wherein the determining whether the loop code satisfies the predefined condition, comprises determining whether the loop code does not include any memory access code or function call code.

4. The operating method of claim 1, further comprising, before calculating the loop code:
determining an initial value of an induction variable included in the loop code.

5. The operating method of claim 4, wherein the determining the initial value of the induction variable, comprises storing the determined initial value in the interpreter frame.

6. The operating method of claim 1, wherein the interpreter calculates the loop code using an extended operator corresponding to an operator of a code included in the original IR.

7. The operating method of claim 1, wherein the interpreter frame is allocated to a memory separately from a virtual register used by the compiler.

8. The operating method of claim 7, wherein the interpreter further includes a mapping table, which stores a mapping relationship between the interpreter frame and the virtual register.

9. (canceled)

10. The operating method of claim 7, wherein the interpreter frame includes a first unit frame and a second unit frame, which are consecutive to each other, and the first unit frame and the second unit frame are mapped to a single value or a single virtual register.

11. The operating method of claim 7, wherein the access code includes a code storing the result stored in the interpreter frame in a virtual register corresponding to the interpreter frame.

12. The operating method of claim 1, wherein the loop code includes at least one induction variable and at least one non-induction variable and a number of iterations of the loop code is determined by both the at least one induction variable and the at least one non-induction variable.

13. The operating method of claim 12, wherein a loop condition of the loop code includes both the at least one induction variable and the at least one non-induction variable.

14-15. (canceled)

16. An operating method of a semiconductor device, comprising:
compiling, by a compiler, source code to generate an original Intermediate Representation (IR);
searching the original IR for a loop code;
generating an Extended IR (EIR) code that corresponds to an IR code included in the loop code and includes an extended operator corresponding to an operator of the IR code;
calculating, by an interpreter separate from the compiler, the EIR code by executing the extended operator;
substituting the loop code in the original IR with an access code for accessing a result of the calculating the EIR code to generate an updated IR; and
compiling, by the compiler, the updated IR.

17. The operating method of claim 16, wherein the EIR code further includes the IR code.

18. The operating method of claim 16, wherein the EIR code includes interpreter frame information regarding an interpreter frame allocated to a memory separately from a virtual register used by the compiler.

19. (canceled)

20. The operating method of claim 16, wherein the access code includes virtual register information regarding a virtual register corresponding to an interpreter frame in which the result is stored.

21-40. (canceled)

41. A method of optimizing a computer program, the method comprising:
compiling source code into an original Intermediate Representation (IR);
determining whether loop code in the original IR satisfies a condition;
executing the loop code to generate a result value, substituting the loop code in the original IR with an access code for accessing the result value to generate an updated IR and compiling the updated IR into target code, when the determining determines the loop code satisfies the condition; and
compiling the original IR into the target code, when the loop code does not satisfy the condition.

42. The method of claim 41, wherein the executing is performed by an Interpreter.

43. The method of claim 41, wherein the loop code satisfies the condition when the loop code is determined not to include any memory access code or function call code.

44. The method of claim 41, wherein the loop code satisfies the condition when the loop code is determined to be an innermost loop or determined to include a single exit point.
